(19) United States
(12) Patent Application Publication
(10) Pub. No.: US 2023/0028087 A1
(43) Pub. Date: Jan. 26, 2023

(54) CONTROL APPARATUS, IMAGE PROJECTION SYSTEM, CONTROL METHOD, AND STORAGE MEDIUM

(71) Applicant: CANON KABUSHIKI KAISHA, Tokyo (JP)

(72) Inventors: Ryosuke Naito, Saitama (JP); Michihisa Yanagi, Tochigi (JP)

(21) Appl. No.: 17/813,604

(22) Filed: Jul. 19, 2022

(30) Foreign Application Priority Data
Jul. 20, 2021 (JP) 2021-119290

(51) Int. Cl. H04N 9/31; G06T 7/70

(52) U.S. Cl. CPC H04N 9/3194; H04N 9/3182; H04N 9/3147; G06T 7/70

(57) ABSTRACT

A control apparatus includes a control unit that adjusts at least one of a color and luminance of a projection image for each group of the plurality of projection apparatuses based on information on the group and a captured image obtained by imaging projection images of the plurality of projection apparatuses using the pickup apparatus. The control unit acquires each of positions of a plurality of projection areas of the plurality of projection apparatuses based on the captured image, and generates, as the information on the group, information indicating that two projection apparatuses corresponding to a first projection area and a second projection area belong to the same group in a case where a distance between the first projection area and the second projection area among the plurality of projection areas is smaller than a predetermined threshold.

### BACKGROUND

### Technical Field

The disclosure relates to a control apparatus that controls a plurality of image projection apparatuses (projectors).

### Description of the Related Art

Conventionally, there is known multi-projection for projecting a plurality of projection images as a single virtual image using a plurality of projectors. In order to make inconspicuous a joint between images, a luminance difference and/or a color difference caused by individual differences among the plurality of projectors are adjusted. Since the manual adjustment is arduous for the user, an automatic adjustment method using a camera has been proposed.

Japanese Patent Laid-Open No. (“JP”) 2017-083672 discloses an image projection system that captures images projected from a plurality of projectors using a camera and automatically adjusts the plurality of projectors so as to equalize colors at a position specified by the user among the captured images. JP 2017-129701 discloses an image projection system that captures images projected from a plurality of projectors using a camera and corrects a correction target area set as an area other than target areas that are the projection images.

In the color adjustment between projection surfaces in the multi-projection, each of the image projection systems disclosed in JPs 2017-083672 and 2017-129701 adjusts the colors of the projection surfaces within an angle of view of the camera to the same color. Thus, in a case where there are a plurality of target colors, imaging and color adjustment is to be performed for each color and thus the overall adjustment needs a long time.

### SUMMARY

A control apparatus is configured to control a plurality of projection apparatuses and a pickup apparatus. The control apparatus includes at least one processor, and at least one memory coupled to the at least one processor storing instructions that, when executed by the at least one processor, cause the at least one processor to function as a control unit configured to adjust at least one of color and luminance of a projection image for each group of the plurality of projection apparatuses based on information on the group and a captured image obtained by imaging projection images of the plurality of projection apparatuses using the image pickup apparatus, and a communication unit configured to transmit information on the at least one that has been adjusted by the control unit to at least one of the plurality of projection apparatuses. The control unit acquires each of positions of a plurality of projection areas of the plurality of projection apparatuses based on the captured image, and generates, as the information on the group, information indicating that two projection apparatuses corresponding to a first projection area and a second projection area belong to the same group in a case where a distance between the first projection area and the second projection area among the plurality of projection areas is smaller than a predetermined threshold. A control method corresponding to the above control apparatus and a non-transitory computer-readable storage medium storing a program that causes a computer to execute the above control method also constitute another aspect of the embodiments.

Further features of the disclosure will become apparent from the following description of exemplary embodiments with reference to the attached drawings.

### BRIEF DESCRIPTION OF THE DRAWINGS

FIG. 1 is a configuration diagram of an image projection system according to this embodiment.

FIG. 2 is a block diagram of the image projection system according to this embodiment.

FIG. 3 is a flowchart of color/luminance adjustment processing according to this embodiment.

FIG. 4 is a captured image of a detection image according to this embodiment.

FIG. 5 is an explanatory diagram of a distance between projection areas in this embodiment.

### DESCRIPTION OF THE EMBODIMENTS

Referring now to the accompanying drawings, a detailed description will be given of embodiments according to the disclosure.

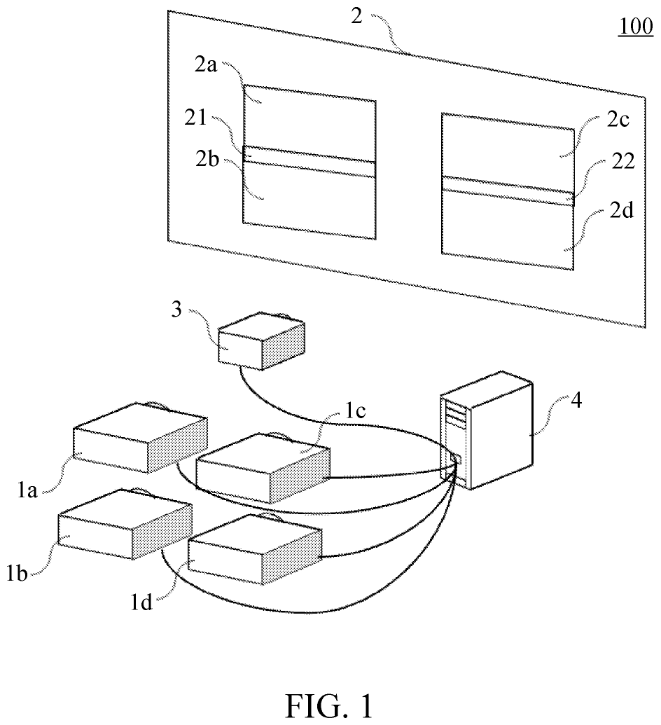

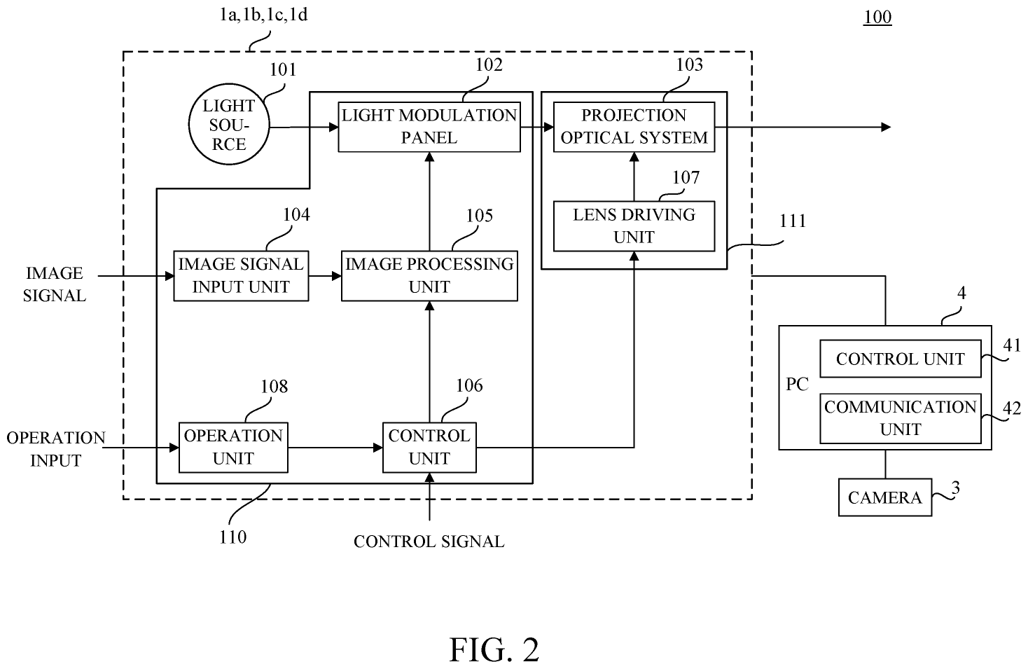

Referring now to FIG. 1, a description will be given of a configuration of an image projection system 100 according to this embodiment. FIG. 1 is a configuration diagram of an image projection system 100. FIG. 2 is a block diagram of the image projection system 100. The image projection system 100 includes a first projector (first image projection apparatus) 1a, a second projector (second image projection apparatus) 1b, a third projector (third image projection apparatus) 1c, and a fourth projectors (fourth image projection apparatus) 1d. The first to fourth projectors 1a to 1d can project projection images (first to fourth images 2a to 2d) on a projection surface 2 such as a screen, respectively. The image projection system 100 includes a camera (image pickup apparatus) 3 for capturing the projection images and a personal computer (PC) 4. The PC 4 serves as a control apparatus that controls the first to fourth projectors 1a to 1d and the camera 3.

The first projector 1a projects and displays the first image 2a on the projection surface 2. The second projector 1b projects and displays the second image 2b on the projection surface 2. The third projector 1c projects and displays the third image 2c on the projection surface 2. The fourth projector 1d projects and displays the fourth image 2d on the projection surface 2. The first image 2a and the second image 2b have an overlapping area 21 in which they vertically overlap each other on or near the joint, and one large screen image is displayed by the first image 2a and the second image 2b. Similarly, the third image 2c and the fourth image 2d have an overlapping area 22 in which they vertically overlap each other on or near the joint, and one large screen image is displayed by the third image 2c and the fourth image 2d.

The camera 3 captures the projection images, that is, the first to fourth images 2a to 2d, displayed on the projection surface 2. The PC 4 controls the first to fourth projectors 1a to 1d using the captured image (data relating to the captured image) that has been acquired by capturing the projection images using the camera 3. The PC 4 includes a control unit 41 and a communication unit 42. The control unit 41 adjusts at least one of the color and luminance of the projection image for each group based on information on the group of each of the first to fourth projectors 1a to 1d and data on the captured image acquired by capturing the projection images of the first to fourth projectors 1a to 1d using the camera 3. The communication unit 42 transmits information (adjustment value) on at least one of the color and luminance adjusted by the control unit 41 to at least one of the first to fourth projectors 1a to 1d. The adjustment value transmitted from the communication unit 42 is written in at least one of the first to fourth projectors 1a to 1d.

Referring now to FIG. 2, a description will be given of the internal configuration of each of the first to fourth projectors 1a to 1d. FIG. 2 is a block diagram of the image projection system 100. In FIG. 2, since the first to fourth projectors 1a to 1d have common internal configurations, each projector is illustrated as one representative block.

Each projector includes a light source 101, a light modulation unit 110, and a lens unit 111 including a projection optical system 103. The lens unit 111 includes a lens driving unit 107 that performs zoom driving, focus driving, and shift (image stabilization) driving of the projection optical system 103.

The light source 101 includes a discharge arc tube, an LED, or a laser, and emits illumination light. The light modulation unit 110 includes a light modulation panel (light modulation element) 102, an image signal input unit (input unit) 104, an image processing unit 105, an operation unit 108, and a control unit 106. The image signal input unit 104 includes terminals for inputting various image signals such as a VGA signal, a DVI signal, an HDMI (registered trademark) signal from the outside of each projector, and a receiver IC and the like for receiving the image signal input through one of these terminals. The image signal input unit 104 outputs the input image signal to the image processing unit 105.

The image processing unit 105 performs various image processing such as color unevenness correction, gamma correction, contrast correction, color conversion, edge blend correction, and keystone correction, for the input image signal, and generates a panel driving signal for driving the light modulation panel 102 based on the processed image signal. The image processing unit 105 further generates a panel driving signal to which an On-Screen Display (OSD) image signal for superimposing and displaying an OSD image for displaying various setting menus and the like is added to the processed image signal.

The light modulation panel 102 includes a liquid crystal panel, a digital micromirror device, or the like, and modulates the illumination light from the light source 101 according to the panel driving signal to generate image light. The projection optical system 103 magnifies and projects the image light from the light modulation panel 102 onto the projection surface. Thereby, an image corresponding to the input image signal is projected and displayed.

The operation unit 108 includes an operation member operable by a user who makes various settings for the projector, an infrared receiver unit for receiving an infrared signal from a remote controller, and the like, and outputs the operation signal in response to the operation of the operation member or the infrared reception. The control unit 106 includes a microcomputer including a CPU, a memory, and the like, gives an instruction to the image processing unit 105 according to the operation signal, and controls the lens driving unit 107.

As described above, the camera 3 captures the first to fourth images 2a to 2d (that is, the projection images projected based on the input image signal input from the image signal input unit 104) projected on the projection surface 2 by the first to fourth projectors 1a to 1d.

The PC 4 is connected to the first to fourth projectors 1a to 1d and the camera 3 by wire or wirelessly, instructs the camera 3 to capture an image, and instructs the first to fourth projectors 1a to 1d to project a test chart. As described above, the PC 4 performs adjustment processing for adjusting at least one of the luminance and color (gamut) of the first to fourth projectors 1a to 1d using the captured image generated by imaging of the camera 3.

In this embodiment, the PC 4, the first to fourth projectors 1a to 1d, and the camera 3 are configured as apparatuses different from each other. However, the camera 3 may be incorporated into any of the projectors, or the PC 4 may be incorporated into any of the projectors.

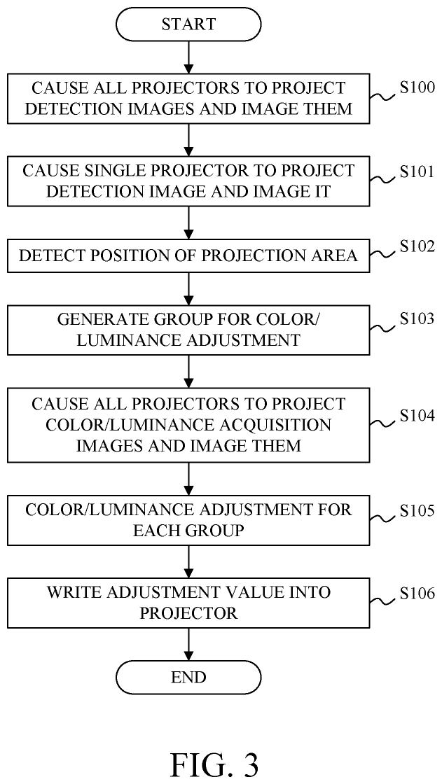

Referring now to FIG. 3, a description will be given of color/luminance adjustment processing (control method) according to this embodiment. FIG. 3 is a flowchart of the color/luminance adjustment processing. Each step in FIG. 3 is mainly performed by the PC 4. The color/luminance adjustment processing is mainly adjustment processing for adjusting at least one of the luminance and color gamut of the first to fourth projectors 1a to 1d.

The PC 4 starts this adjustment processing according to a computer program, for example, when the adjustment using the camera of the first to fourth projectors 1a to 1d is selected in a menu called by a user operation of the operation unit 108. However, this embodiment is not limited to this example, and the PC 4 may automatically start this adjustment processing in a case where the PC 4 receives an instruction to execute this adjustment processing from an external device or where the PC 4 is programmed to issue an instruction to execute the adjustment processing at regular intervals.

First, in step S100, the PC 4 controls the first to fourth projectors 1a to 1d, and causes the first to fourth projectors 1a to 1d to simultaneously project detection images (first to fourth images 2a to 2d) onto the projection surface 2. Here, the detection image may be a white image (solid white image) having the maximum overall luminance, but a white image having an intermediate gradation or an image in another color (such as red, green, and blue) may be projected. The detection image is generated by the image processing unit 105 or input as the image signal to the image signal input unit 104 and then projected. Then, the PC 4 controls the camera 3 to cause it to capture the detection image.

Next, in step S101, the PC 4 causes the first projector 1a to solely project the detection image (first image 2a) on the projection surface 2 and the second to fourth projectors 1b to 1d to project black images (solid black images) having minimum overall luminances on the projection surface 2. Here, similarly to step S100, the detection image may be a solid white image. Then, the PC 4 controls the camera 3 to capture the solid white image and solid black images. Alternatively, instead of causing the second to fourth projectors 1b to 1d to project the solid black images, the light sources 101 in the second to fourth projectors 1b to 1d may be turned off, or illumination light that is to enter the light modulation panel 102 may be shielded by an unillustrated shutter. By repeating these processes for the number of projectors, four captured images are obtained after the first to fourth projectors 1a to 1d solely project the detection images (first to fourth images 2a to 2d) onto the projection surface 2.

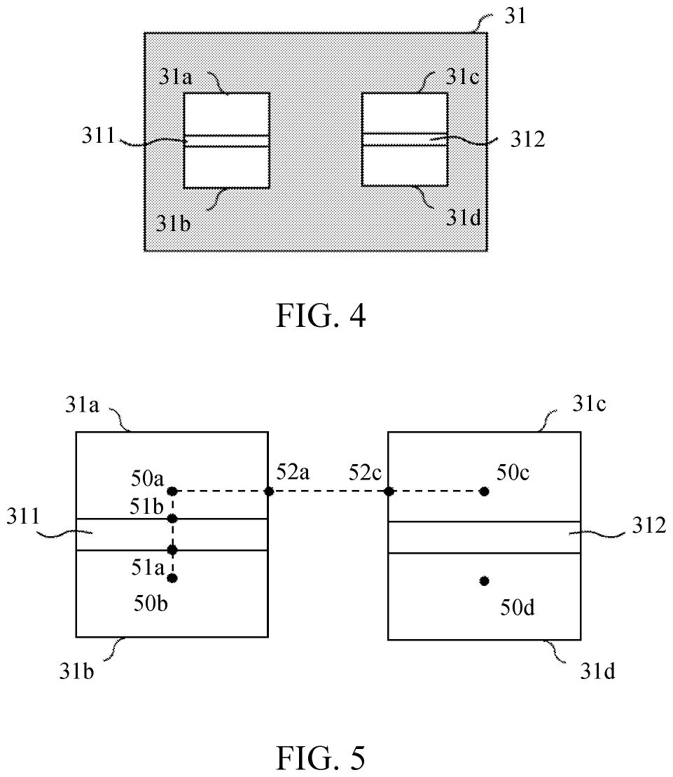

FIG. 4 is a captured image (first captured image data) 31 obtained by capturing solid white images (detection images) projected on projection areas 31a to 31d by the first to fourth projectors 1a to 1d in step S100. In the captured images (second to fifth captured image data) obtained by capturing the solid white image solely projected by each projector in step S101, a single projection image in each of the projection areas 31a to 31d is a recognizable image (not illustrated).

Next, in step S102, the PC 4 detects the position of the projection area using the captured images obtained in steps S100 and S101. Each projection area is detected by detecting vertices of the solid white image projected by a Laplace operator, Harris operator, etc., and by detecting an area surrounded by straight lines connecting these vertices. The PC 4 can also detect, as the projection area, the largest area of a continuous area having a pixel value equal to or larger than a predetermined pixel value in the captured images.

Next, in step S103, the PC 4 generates a group of projectors having the same target luminance and/or color gamut in the color/luminance adjustment. Here, conceivably, there are some methods of generating the group in the color/luminance adjustment.

In the first group generating method, the PC 4 generates groups according to a distance between two projection areas (between a first projection area and a second projection area) among the projection areas 31a to 31d. Referring now to FIG. 5, a description will be given of a first group generating method. FIG. 5 is an explanatory diagram of the distance between the projection areas, and extracts part of the projection areas from the captured image in FIG. 4. Here, representative points 50a to 50d are calculated from the projection areas 31a to 31d. The representative point is a coordinate of a pixel representing the projection area, which may be a coordinate of a center of gravity (central portion) of the projection area or a coordinate of the maximum luminance, but the representative point may be any of the coordinates constituting the projection area. Line segments connecting the representative points 50a to 50d may be calculated.

FIG. 5 illustrates a dotted line segment connecting the representative points 50a and 50b to each other and a dotted line segment connecting the representative points 50a and 50c, and 51a, 51b, 52a, and 52c that are intersections between the line segments and the edges (ends) of the projection areas. The distance between the projection areas can be calculated by calculating a distance between these intersections. In a case where the calculated intersection is included in the projection area constituting the representative point, like the intersections 51a and 51b, the distance is defined as 0. For example, where (x₅₂ₐ, y₅₂ₐ) is a coordinate of the intersection 52a and (x_{52c}, y_{52c}) is a coordinate of the intersection 52c, a distance D can be calculated by the following expression (1):

D=\sqrt{(x₅₂ₐ−x_{52c})²+(y₅₂ₐ−y_{52c})²} (1)

Where the distance between the projection areas is equal to or smaller than a predetermined value (predetermined threshold), the PC 4 generates a group of the projectors constituting the representative point. That is, in the case where the distance between the first projection area and the second projection area is smaller than the predetermined value, the control unit 41 generates, as the information on the group, information indicating that two image projection apparatuses corresponding to the first projection area and the second projection area belong to the same group. On the other hand, when the distance between the projection areas is larger than the predetermined value, the PC 4 determines that they are different groups and does not generate a group. Although the predetermined value can be arbitrarily set, it may be set based on an area ratio between the projection area and the captured image. For example, the larger the area ratio of the projection area to the captured image is, the larger the predetermined value is set, and the smaller the area ratio of the projection area to the captured image, the smaller the predetermined value is set. This processing generates a group including the projection areas 31a and 31b, and a group including the projection areas 31c and 31d.

In the second group generating method, the PC 4 generates a group according to the presence or absence of an overlapping area between two projection areas (first projection area and second projection area) among the projection areas 31a to 31d. In FIG. 4, the projection areas 31a and 31b have an overlapping area 311, and the projection areas 31c and 31d have an overlapping area 312. In one embodiment, the captured image of the single projection image obtained in step S101 is used to determine the overlapping area. In the second captured image data, only the projection area 31a is detected, and in the third captured image data, only the projection area 31b is detected. Thus, in any of the captured images, the coordinate regarded as the projection area is set to the overlapping area. If this overlapping area exists even by one pixel, a group is generated between the projectors constituting the overlapping area. That is, in the case where there is an overlapping area between the first projection area and the second projection area, the control unit 41 generates, as the information on the group, information indicating that two image projection apparatuses corresponding to the first projection area and the second projection area belong to the same group.

In the determination of the overlapping area, a predetermined value (threshold for determining that there is an overlapping area) may be set based on the area ratio between the overlapping area and the projection area, and whether or not the area ratio is larger than the predetermined value may be determined. In that case, if the overlapping area has an area ratio larger than the predetermined value relative to the projection area, a group is generated, and if the overlapping area has an area ratio smaller than the predetermined value, a group is not generated. This processing generates a group including the projection areas 31a and 31b, and a group including the projection areas 31c and 31d.

In the third group generating method, the PC 4 generates a group based on setting information set in the projector. In the projector, an image quality mode can be switched according to the content to be projected and the user's preference. For example, the image quality mode can be set, such as an sRGB image quality mode that faithfully reproduces an input signal designed in the sRGB color gamut, a presentation image quality mode that improves the appearance of a presentation in a conference room, and the like. A group is generated for projectors that have the same image quality mode. In addition to the image quality mode, a group may be generated for projectors that have the same setting according to an input signal input to the projector, information set to the projector by the user through the operation unit 108, and the like. The user may set a group for the color/luminance adjustment by himself/herself. In that case, the user may make settings on the projector body by the operation unit 108 or may make settings on the application of the PC 4 (not illustrated). The setting information of the projector is stored in a storage such as a memory of the control unit 106, and can be transferred to the PC 4 by a command or the like. Thus, in the case where the setting information set in the projector or the PC 4 is the same, the control unit 41 generates, as the information on the group, information indicating that at least two projectors belong to the same group.

In the fourth group generating method, the PC 4 generates a group based on model information of the projector and model information of the projection optical system in the projector. The model information of the projector is identified as different model information due to a difference in component type such as a light source and a light modulation panel, and a difference in component performance such as a projection luminance and resolution. For example, the component of the light source 101 includes a discharge arc tube, an LED, a laser, and the like. The component of the light modulation panel 102 includes a liquid crystal panel, a digital micromirror device, and the like. A group is generated for projectors that have the same type and performance of these components. In the projection optical system, different model information is identified due to a difference in component type such as a lens member and design, and a difference in component performance such as an F-number, projection ratio, and zoom magnification of the lens. A group is generated for projectors that have projection optical systems having the same type and performance of these components. Information on the type and performance of the component is stored in the memory of the control unit 106 and can be transferred to the PC 4 by a command or the like. Thus, in the case where information on the model of the projector or the projection optical system is the same, the control unit 41 generates, as the information on the group, information indicating that at least two image projection apparatuses having the same model or the same projection optical system belong to the same group.

Regarding the group generating method, the number of projectors that constitute a group does not have to be two, and the upper limit can be arbitrarily set. The number of groups does not have to be two, and the upper limit can be arbitrarily set. The number of projectors does not have to be four, but may be two or more, or may be three or more for classification into a plurality of groups.

Next, in step S104, the PC 4 causes the first to fourth projectors 1a to 1d to simultaneously project color/luminance acquisition images (first to fourth images) onto the projection surface 2. Here, the color/luminance acquisition image may be a white image, a red image, a green image, or a blue image having the maximum overall luminance. In a case where it is also desired to adjust at least one of the color and luminance of the intermediate gradation, a white image, a red image, a green image, or a blue image having a corresponding gradation may be used. The detection image is generated by the image processing unit 105, or input as an image signal to the image signal input unit 104 and thereby is projected. The PC 4 causes the color/luminance acquisition images to be sequentially projected, and causes the camera 3 to capture them. The first to fourth projectors 1a to 1d may solely project the color/luminance acquisition images and the camera 3 may capture them. In particular, in the case where the overlapping area of the projectors is approximately the same as the projection area, the luminance or color gamut of each projector cannot be properly acquired, so the color/luminance acquisition image may be solely (or independently) projected.

Next, in step S105, the PC 4 adjusts at least one of the color and luminance of the projector for each group using the group information (information on the group) generated in step S103 and the captured image obtained in step S104. First, in the projection area detected in step S102, a representative value for the color/luminance adjustment is generated. The representative value represents an average value, a median value, a maximum luminance value, or the like of the pixel values belonging to the projection area of each projector in the captured image obtained in step S104. Thereafter, the adjustment value is calculated so that the representative values of respective projectors substantially accord with each other. For example, when a white image having the maximum overall luminance is projected as a color/luminance acquisition image, assume that the representative value of the first projector 1a is (R_{w1a}, G_{w1a}, B_{w1a}), and the representative value of the second projector 1b is (R_{w1b}, G_{w1b}, B_{w1b}). At this time, a gain coefficient (r_{w1}, g_{w1}, b_{w1}) is calculated so that the representative values of the respective projectors substantially accord with each other. The gain coefficient is a numerical value that satisfies R_{w1a}=r_{w1}R_{w1b}, G_{w1a}=g_{w1}G_{w1b}, and B_{w1a}=b_{w1}B_{w1b}.

The above example calculates the gain coefficient for adjusting the second projector 1b using the first projector 1a as a reference, but the reference projector can be arbitrarily changed. The above example calculates the gain coefficient using the white image having the maximum overall luminance, but may calculate the gain coefficient using the red image, the green image, or the blue image. In adjusting the color and/or luminance of the intermediate gradation, the gamma coefficient or the gamma table may be calculated as the adjustment value, or 3D Look-Up Table (3DLUT) may be calculated as the adjustment value. By repeating this procedure for the number of groups, the adjustment value of all projectors can be calculated. The adjustment value of projectors that do not belong to a group is not calculated.

Finally, in step S106, the PC 4 writes the adjustment value calculated in step S105 into the first to fourth projectors 1a to 1d. The written adjustment value is stored in the memory of the control unit 106 of each projector, and is applied by the image processing unit 105. Projectors for which adjustment values have not been calculated (projectors that do not belong to a group) may not be operated, and in an attempt to cancel a state in which the previous adjustment values are written, the initial value stored in the memory of the control unit 106, or the like may be restored.

In this embodiment, the first to fourth projectors project images arranged in the vertical direction, but images arranged in the horizontal direction may be projected, and one image may include the other image. As described above, at least one of the luminance and color gamut of the projection image in multi-projection can be solely adjusted for each group, and the adjustment time can be finally shortened.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application-specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

As described above, in this embodiment, the control unit 41 adjusts at least one of the color and luminance of the projection image for each group based on the information on the group of a plurality of projectors and the data on the captured image obtained by capturing the projection images of the plurality of projectors using the camera 3. The control unit 41 adjusts at least one of the color and luminance for each group so as to reduce a difference in color or luminance of the projection images of the projectors belonging to the same group. This embodiment can provide a control apparatus, an image projection apparatus, a control method, and a storage medium, each of which can adjust at least one of the color and luminance of a projection image in a multi-projection in a short time.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-119290, filed on Jul. 20, 2021, which is hereby incorporated by reference herein in its entirety.

What is claimed is:

1. A control apparatus configured to control a plurality of projection apparatuses and a pickup apparatus, the control apparatus comprising:
at least one processor; and
at least one memory coupled to the at least one processor storing instructions that, when executed by the at least one processor, cause the at least one processor to function as:
a control unit configured to adjust at least one of a color and luminance of a projection image for each group of the plurality of projection apparatuses based on information on the group and a captured image obtained by imaging projection images of the plurality of projection apparatuses using the pickup apparatus; and
a communication unit configured to transmit information on the at least one that has been adjusted by the control unit to at least one of the plurality of projection apparatuses,
wherein the control unit
acquires each of positions of a plurality of projection areas of the plurality of projection apparatuses based on the captured image, and
generates, as the information on the group, information indicating that two projection apparatuses corresponding to a first projection area and a second projection area belong to the same group in a case where a distance between the first projection area and the second projection area among the plurality of projection areas is smaller than a predetermined threshold.

2. The control apparatus according to claim 1, wherein the control unit adjusts the at least one for each group so as to reduce a difference in the at least one among the projection images of the projection apparatuses belonging to the same group.

3. The control apparatus according to claim 1, wherein the distance between the first and second projection areas is a distance between a central portion of the first projection area and a central portion of the second projection area.

4. The control apparatus according to claim 1, wherein the distance between the first and second projection areas is a distance between an end of the first projection area and an end of the second projection area.

5. The control apparatus according to claim 1, wherein the control unit changes the predetermined threshold based on an area ratio between the projection image and the captured image.

6. The control apparatus according to claim 1, wherein the control unit
acquires each of the positions of the plurality of projection areas of the plurality of projection apparatuses based on the captured image, and
generates, as the information on the group, the information indicating that the two projection apparatuses corresponding to the first projection area and the second projection area belong to the same group in a case where there is an overlapping area between the first projection area and the second projection area among the plurality of projection areas.

7. The control apparatus according to claim 6, wherein the control unit changes a threshold for determining that there is the overlapping area based on an area ratio of the overlapping area and the projection image.

8. The control apparatus according to claim 1, wherein in a case where setting information set to the projection apparatus or setting information set to the control unit is equal to each other, the control unit generates, as the information on the group, information indicating that at least two projection apparatuses to which the same setting information is set belong to the same group.

9. The control apparatus according to claim 1, wherein in a case where information on a model of the projection apparatus or a system of the projection apparatus is the same, the control unit generates, as the information on the group, information indicating that the at least two image projection images having the same model or the same system belong to the same group.

10. A system comprising:
a plurality of projection apparatuses; and
a pickup apparatus configured to capture a plurality of projection images projected by the plurality of projection apparatuses; and
a control apparatus configured to control the plurality of projection apparatuses and the pickup apparatus,
wherein the control apparatus includes:
at least one processor; and
at least one memory coupled to the at least one processor storing instructions that, when executed by the at least one processor, cause the at least one processor to function as:
a control unit configured to adjust at least one of a color and luminance of a projection image for each group of the plurality of projection apparatuses based on information on the group and a captured image obtained by imaging projection images of the plurality of projection apparatuses using the pickup apparatus; and
a communication unit configured to transmit information on the at least one that has been adjusted by the control unit to at least one of the plurality of projection apparatuses,
wherein the control unit
acquires each of positions of a plurality of projection areas of the plurality of projection apparatuses based on the captured image, and
generates, as the information on the group, information indicating that two projection apparatuses corresponding to a first projection area and a second projection area belong to the same group in a case where a distance between the first projection area and the second projection area among the plurality of projection areas is smaller than a predetermined threshold.

11. A method of controlling a plurality of projection apparatuses and a pickup apparatus, the control method comprising:
adjusting at least one of a color and luminance of a projection image for each group of the plurality of projection apparatuses based on information on the group and a captured image obtained by imaging projection images of the plurality of projection apparatuses using the pickup apparatus; and
transmitting information on the at least one that has been adjusted by the adjusting to at least one of the plurality of projection apparatuses;
acquiring each of positions of a plurality of projection areas of the plurality of projection apparatuses based on the captured image; and
generating, as the information on the group, information indicating that two projection apparatuses corresponding to a first projection area and a second projection area belong to the same group in a case where a distance between the first projection area and the second projection area among the plurality of projection areas is smaller than a predetermined threshold.

12. The method according to claim 11, wherein the adjusting adjusts the at least one for each group so as to reduce a difference in the at least one among the projection images of the projection apparatuses belonging to the same group.

13. The method according to claim 11, wherein the distance between the first and second projection areas is a distance between a central portion of the first projection area and a central portion of the second projection area.

14. The method according to claim 11, wherein the distance between the first and second projection areas is a distance between an end of the first projection area and an end of the second projection area.

15. The method according to claim 11, further comprising changing the predetermined threshold based on an area ratio between the projection image and the captured image.

16. A non-transitory computer-readable storage medium storing a program that causes a computer to execute a method, the method comprising:
adjusting at least one of a color and luminance of a projection image for each group of the plurality of projection apparatuses based on information on the group and a captured image obtained by imaging projection images of the plurality of projection apparatuses using the pickup apparatus;
transmitting information on the at least one that has been adjusted by the adjusting to at least one of the plurality of projection apparatuses;
acquiring each of positions of a plurality of projection areas of the plurality of projection apparatuses based on the captured image, and
generating, as the information on the group, information indicating that two projection apparatuses corresponding to a first projection area and a second projection area belong to the same group in a case where a distance between the first projection area and the second projection area among the plurality of projection areas is smaller than a predetermined threshold.

17. The non-transitory computer-readable storage medium according to claim 16, wherein the adjusting adjusts the at least one for each group so as to reduce a difference in the at least one among the projection images of the projection apparatuses belonging to the same group.

18. The non-transitory computer-readable storage medium according to claim 16, wherein the distance between the first and second projection areas is a distance between a central portion of the first projection area and a central portion of the second projection area.

19. The non-transitory computer-readable storage medium according to claim 16, wherein the distance between the first and second projection areas is a distance between an end of the first projection area and an end of the second projection area.

20. The non-transitory computer-readable storage medium according to claim 16, further comprising changing the predetermined threshold based on an area ratio between the projection image and the captured image.
